(19) United States
(12) Patent Application Publication
(10) Pub. No.: US 2016/0304224 A1
(43) Pub. Date: Oct. 20, 2016

(54) DOVETAIL STRAP CUTTER IN A STRAP SEALING MACHINE

(71) Applicant: Signode Industrial Group LLC, Glenview, IL (US)

(72) Inventors: Michael Brydon Foy, Skokie, IL (US); Dustin Elliott, Grayslake, IL (US)

(21) Appl. No.: 15/053,697

(22) Filed: Feb. 25, 2016

Related U.S. Application Data
(60) Provisional application No. 62/147,264, filed on Apr. 14, 2015.

(51) Int. Cl. B65B 13/18; B26D 5/06

(52) U.S. Cl. CPC B65B 13/185; B26D 5/06

(57) ABSTRACT

A strap sealing module is provided. The strap sealing module includes a moving cutter having a first shearing surface and a first dovetail member and a bearing plate having a second dovetail member. The first dovetail member is matingly and slidably coupled with the second dovetail member to slidably couple the moving cutter to the bearing plate. The machine also includes a stationary cutter fixedly secured to the bearing plate, the stationary cutter having a second shearing surface. A strap feed path is defined between the moving cutter and the stationary cutter. The moving cutter is slidable along the bearing plate in a first direction toward the stationary cutter so as to overlap the stationary cutter by a predetermined clearance in a cutting position and slidable in a second direction away from the stationary cutter to a retracted position.

### CROSS-REFERENCE TO RELATED APPLICATION DATA

This application claims the benefit of and priority to Provisional U.S. Patent Application Ser. No. 62/147,264, filed Apr. 14, 2015, the disclosure of which is incorporated herein in its entirety.

### BACKGROUND

The following description relates to a cutter in a strap sealing machine, for example a cutter having a fixed part and a moving part movable along a dovetail guide to cut a strap fed between the moving and fixed parts.

A strapping machine may be used to secure a metal strap around a load of material or products. Typically, a metal strap can be wound around the load so that a feed end of the strap substantially overlaps a trailing end of the strap.

After being wound around the load, the strapping machine may tension the strap around the load so as to securely position the load within the strap. That is, the strap may extend substantially in a loop around the load, and the loop may be tensioned around the load. The strap may then be cut and have overlapping ends sealed to one another so that the strap is securely positioned about the load.

A conventional strapping machine includes a cutting assembly for cutting a feed end of the strap. The cutting assembly is positioned along a strap feed path. The cutting assembly may include a movable part and a fixed part. The strap feed path extends substantially between the moving part and the fixed part. The movable part is moved from a retracted position, across the feed path, to a cutting position. During this movement, the strap is pinched between the moving part and fixed part and is cut or sheared.

When the movable part is moved to the cutting position, a clearance exists between the movable part and the fixed part, substantially in a direction of the strap feed path. Accordingly, a strap that is cut at the cutting assembly may have a bend formed therein resulting from the clearance between the movable and fixed parts. A larger clearance may result in a larger bend in the feed end of the strap which may cause a failed cutting operation.

Efforts have been made to properly position and space the movable and fixed parts relative to one another. In known cutting assemblies, one or more shims are installed in the strapping machine adjacent to the one of or both of the movable part or the fixed part to provide proper clearance therebetween. However, the installation of shims requires additional assembly and/or post manufacturing installation steps. In addition, the shims represent an additional material cost. Further, installing or replacing the shims may result in periods of downtime for the strapping machine, and may otherwise make repair and maintenance more difficult to complete correctly. Moreover, over time, shims have to be replaced to provide accurate and consistent strap cuts. If the shims are incorrectly installed, such that a gap exists between the movable fixed parts of the cutter is too large, the strap may not cut and remain attached to the load, which may interfere with the ability for the load to continue moving along a conveyor.

Accordingly, it is desirable to provide a cutting assembly in a strap sealing machine that eliminates the need for shims and provides proper and measured clearance between a moving cutter and a fixed element of the cutting assembly.

### SUMMARY

According to one embodiment, there is provided a strap sealing module. The strap sealing module includes a moving cutter having a first shearing surface and a first dovetail member and a bearing plate having a second dovetail member. The first dovetail member is matingly and slidably coupled with the second dovetail member to slidably couple the moving cutter to the bearing plate. The strap sealing module further includes a stationary cutter fixedly secured to the bearing plate, the stationary cutter having a second shearing surface. A strap feed path is defined between the moving cutter and the stationary cutter, and the moving cutter is slidable along the bearing plate in a first direction toward the stationary cutter so as to overlap the stationary cutter by a predetermined clearance in a cutting position, and slidable in a second direction away from the stationary cutter to a retracted position.

According to another embodiment, there is provided a cutting assembly for a strap sealing module. The cutting assembly includes a moving cutter having a first shearing surface and a first dovetail member and a bearing plate having a second dovetail member. The first dovetail member is matingly and slidably coupled with the second dovetail member to slidably couple the moving cutter to the bearing plate. The cutting assembly further includes a stationary cutter fixedly secured to the bearing plate, the stationary cutter having a second shearing surface. The moving cutter is slidable along the bearing plate in a first direction toward the stationary cutter so as to overlap the stationary cutter by a predetermined clearance in a cutting position, and slidable in a second direction away from the stationary cutter to a retracted position.

According to another embodiment, there is provided a moving cutter for use in a cutting assembly of a strap sealing module. The moving cutter includes a shearing surface and a dovetail member configured to matingly and slidingly engage a corresponding dovetail member of an adjacent bearing plate.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

FIG. 1 is a perspective view of an example of a sealing module for a strapping machine according to an embodiment described herein;

FIG. 2 is an exploded partial perspective view of a base portion of the module of FIG. 1;

FIG. 3 is a front exploded perspective view showing an example of a bearing plate and cutter assembly of the module of FIG. 1;

FIG. 4 is top plan view of the bearing plate of FIG. 3, according to an embodiment described herein;

FIG. 5 is a cross-sectional view of the bearing plate of FIG. 4 taken at A-A;

FIG. 6 is a bottom perspective view showing an example of a moving cutter for use in the module of FIG. 1;

FIG. 7 is a bottom plan view of the moving cutter of FIG. 4;

FIG. 8 is a front view of the moving cutter of FIG. 4;

FIG. 9 is a top perspective view showing an example of a bearing plate in the module of FIG. 1;

FIG. 10 is a top plan view of the bearing plate of FIG. 9;

FIG. 11 is a front view of the bearing plate of FIG. 9; and

FIG. 12 is another perspective view of the base portion of the module of FIG. 1.

### DETAILED DESCRIPTION

While the present disclosure is susceptible of embodiment in various forms, there is shown in the drawings and will hereinafter be described one or more embodiments with the understanding that the present disclosure is to be considered illustrative only and is not intended to limit the disclosure to any specific embodiment described or illustrated.

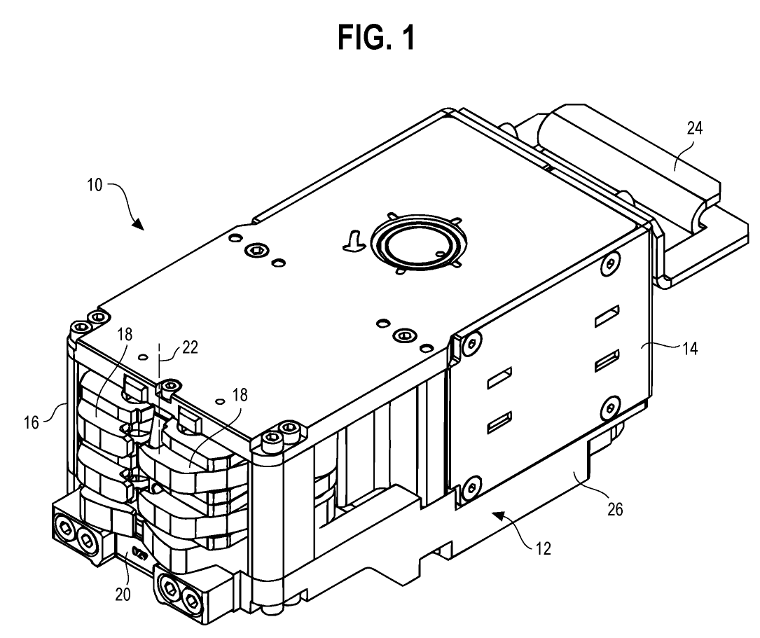

FIG. 1 is perspective view of a sealing module 10 according to an embodiment described herein. Referring to FIG. 1, the sealing module 10 generally includes a base portion 12 and a body or frame 14 mounted to the base portion 12. The sealing module 10 also includes a sealing section 16 having a plurality of notchers 18 and a cutting assembly 20. The notchers 18 may be spaced apart in opposing pairs. A strap feed path 22 extends between opposing pairs of notchers 18 and the cutting assembly 20 such that a strap (not shown) may be fed through the notchers 18 and cutting assembly 20. The sealing module 10 may also have a handle 24 secured thereon to readily remove and replace the module in a strapping machine (not shown).

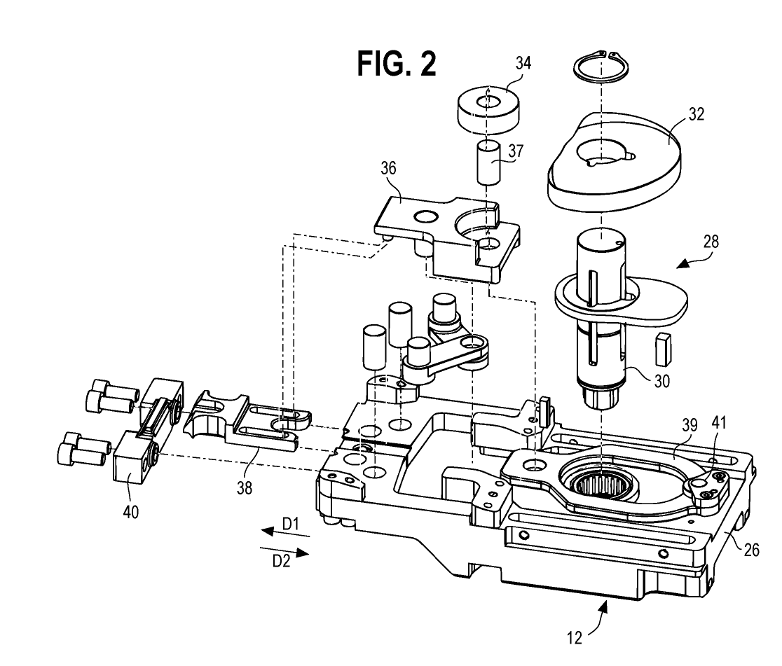

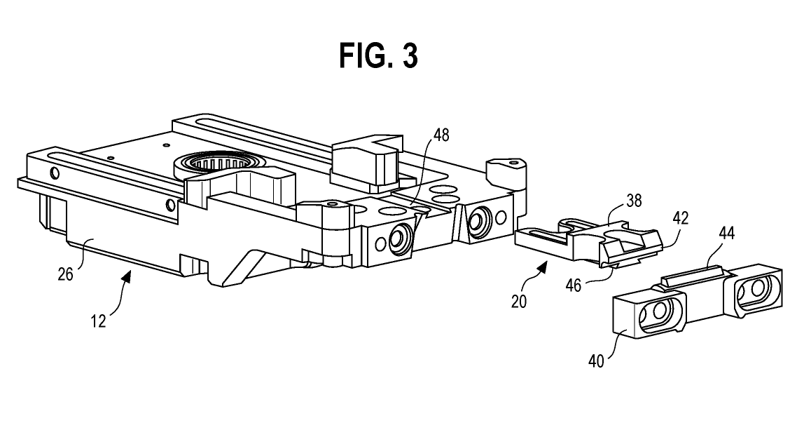

FIG. 2 is an exploded partial perspective view showing an example of the base portion 12 of the sealing module 10 according to an embodiment described herein. FIG. 3 is another exploded perspective view of the base portion 12. In FIGS. 2 and 3, some of the features are omitted to more clearly show other features. Referring to FIGS. 2 and 3, the base portion 12 includes a bearing plate 26. The cutting assembly 20 is configured to be mounted to the bearing plate 26. Further, a cam assembly 28 is configured to be mounted to the bearing plate 26 to drive the notchers 18 and the cutting assembly 20. In the example of the sealing module in FIG. 2, only 2 of 5 cam assemblies 28 are shown. It will be appreciated by those skilled in the art that the number of cam assemblies will vary depending upon the various functions (e.g., sealing and cutting) carried out by the sealing module 10.

Referring to FIG. 2, the cam assembly 28 includes a cam shaft 30 rotatably mounted to the bearing plate 26 and an eccentric cam block 32 rotationally fixed relative to the cam shaft 30 so as to rotate together with the cam shaft 30. The cam assembly 28 further includes a first cam follower 34 configured to be acted on by the eccentric cam block 32. In one embodiment, a cutter block 36 is operably connected to the first cam follower 34. For example, a pin 37 may connect the first cam follower 34 to the cutter block 36. The cam shaft 30 is driven to rotate by a drive assembly. The drive assembly may be formed by, for example, a motor and a gearbox operably connected to the cam shaft 30.

The cam assembly 28 may further include a sliding link 39 slidable in a first direction D1 and a second direction D2, opposite to the first direction D1. The sliding link 39 may be coupled to the follower 34 and cutter block 36 via the pin 37. At an opposite end of the sliding link 39, i.e., at an end positioned on an opposite side of the cam shaft 30 from the first cam follower 34, the cam assembly 28 further includes a second cam follower 41 is to the sliding link 39. In one embodiment, the second cam follower 41 is rotatably coupled to the sliding link 39.

Referring still to FIGS. 2 and 3, the cutting assembly 20 includes a moving cutter 38 and a stationary cutter 40. The moving cutter 38 is slidably positioned on the bearing plate 26 and is configured to be reciprocally driven along the bearing plate 26 by the cam assembly 28 through the cam block 32, the first cam follower 34, the cutter block 36 and the second cam follower 41 as described below. The moving cutter 38 includes a first shearing surface 42. The first shearing surface 42 may be an area of reduced thickness to substantially form a blade on the moving cutter 38. The first shearing surface 42 may be formed on the moving cutter 38, or formed separately and affixed to the moving cutter 38. In one embodiment, the cutter block 36 may be secured to the moving cutter 38, for example, by welding or other similar fastening technique.

The stationary cutter 40 may be fixedly secured to the bearing plate 26. In one embodiment, the stationary cutter 40 is secured to the bearing plate 26 with one or more bolts, screws, or similar fasteners. The stationary cutter 40 includes a second shearing surface 44. The second shearing surface 44 may be an area of reduced thickness to substantially form a blade on the stationary cutter 40. The second shearing surface 44 may be formed on the stationary cutter 40, or formed separately and affixed to the stationary cutter 40.

The moving cutter 38 may be slidable between, for example, a retracted position and a cutting position. In the retracted position, the moving cutter 38 is retracted relative to the stationary cutter 40 such that the strap (not shown) may be fed along the strap feed path 22 between the moving cutter 38 and the stationary cutter 40. In the cutting position, the moving cutter 38 is driven outwardly from the bearing plate 26 toward the stationary cutter 40 by the cam assembly 28 in the first direction D1 such that the moving cutter 38 extends across the strap feed path 22 and overlaps a top portion of the stationary cutter 40. Accordingly, a strap (not shown) may be pinched between the moving cutter 38 and the stationary cutter 40 and cut or sheared by the shearing surfaces 42, 44.

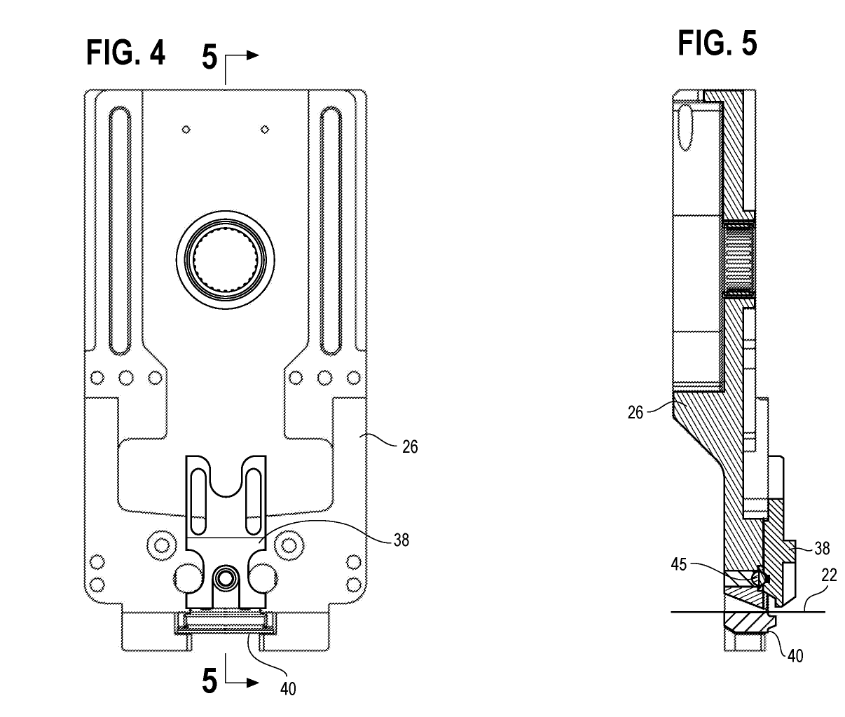

FIG. 4 is top plan view of the bearing plate 26 according to an embodiment described herein, and FIG. 5 is a cross-sectional view of the bearing plate 26 taken at A-A at FIG. 4. Referring to FIGS. 4 and 5, the strap feed path 22 is shown extending between the moving cutter 38 and the fixed cutter 40. In addition, as shown in FIG. 5, a spring-biased ball detent 45 may be positioned in the bearing plate 26 and urged into a recess in the moving cutter 38. Accordingly, the ball detent 45 may hold the moving cutter 38 against inadvertent movement in the retracted position regardless of a position orientation of the bearing plate 26 or module 10. When the moving cutter 38 is driven outwardly to the cutting position by the cam assembly 28, the ball detent 45 is urged by the moving cutter 38, against the spring force, out of the recess in the moving cutter 38. That is, a driving force from the cam assembly 28 to move the moving cutter 38 to the cutting position is sufficient to overcome the spring force holding the ball detent 45 in the moving cutter. The spring urges the ball detent 45 back into the recess of the moving cutter 38 when the moving cutter 38 is returned to the retracted position.

Thus, in the embodiments above, the moving cutter 38 is driven from the retracted position to the cutting position by the cam assembly 28. Rotation of the cam 30 causes rotation of the eccentric cam block 32. The eccentric cam block 32 engages the first cam follower 34. The first cam follower 34 transmits a linear force from the eccentric cam block 32 to the cutter block 36, the sliding link 39 and the moving cutter 38, via the cutter block 36 to drive the moving cutter 38 in the first direction D1.

The moving cutter 38 is driven from the cutting position to the retracted position by continued rotation of the eccentric cam block 32. The eccentric cam block 32 is rotated to engage the second cam follower 41 at the opposite end of the sliding link 39. The eccentric cam block 32 applies a linear force to the second cam follower 41 to drive the second cam follower 41 in the second direction D2. This linear force is transmitted to the sliding link 39 via the coupling between the second cam follower 41 and the sliding link 39 to drive the sliding link 39 in the second direction D2 as well. The sliding link 39, in turn, drives the cutter block 36, moving cutter 38 and first cam follower 34 in the second direction D2 via the coupling pin 37.

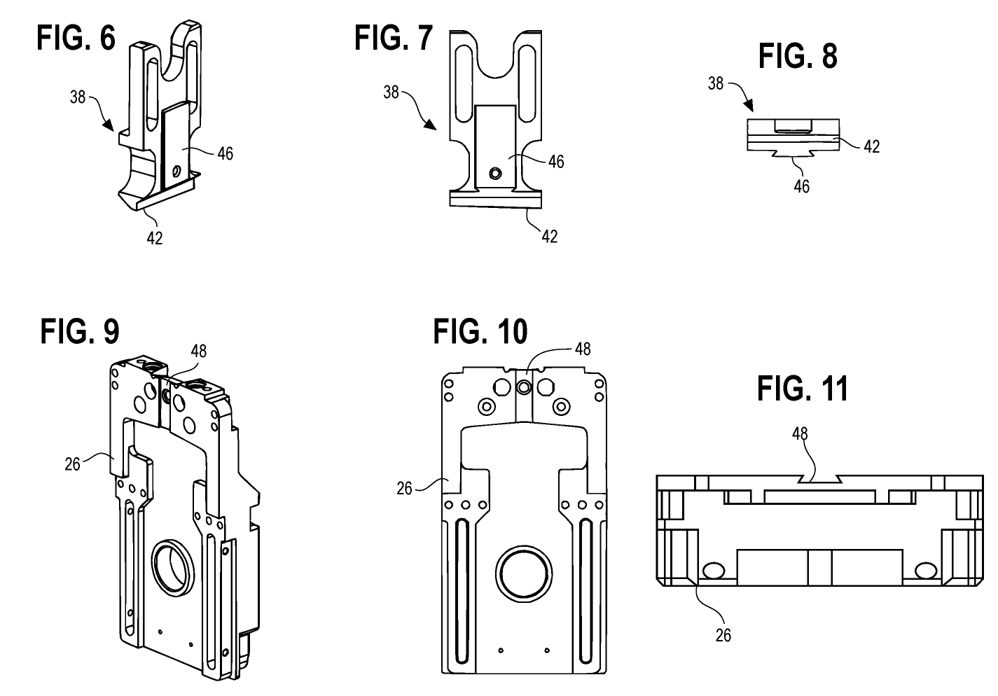

FIGS. 6-8 show various views of the moving cutter 38 and FIGS. 9-11 show various views of the bearing plate 26. Referring to FIGS. 2 and 3, in one embodiment, the moving cutter 38 may be slidingly coupled to the bearing plate 26 via a dovetail coupling. For example, as shown in FIGS. 3 and 6-8, the moving cutter 38 may include a first dovetail member 46 and as shown in FIGS. 2-4 and 9-11 the bearing plate 26 may include a second dovetail member 48. In one embodiment, the first dovetail member 46 is a dovetail projection and the second dovetail member 48 is a dovetail slot. The dovetail projection 46 may be matingly and slidingly received within the dovetail slot 48. However, the present disclosure is not limited to this configuration and it is understood that the first and second dovetail members 46, 48 may be reversed.

The dovetail members 46, 48 define angled surfaces on the dovetail projection that are complementary to angled surfaces on the dovetail slot. Engagement of the dovetail members 46, 48 provides an interference fit so that the moving cutter 38 does not move transverse to the direction of movement D1, D2 of the cutter 38. In this discussion, transverse to the of movement D1, D2 of the cutter is toward and away from the bearing plate 26, so as to prevent creating a gap between the moving cutter 38 and stationary cutter 40. In this manner, the dovetail members 46, 48 eliminate the need for shims as are used in known cutters between the movable cutter and the bearing plate.

As shown in FIGS. 2-11, the first dovetail member 46, for example, the dovetail projection, may be formed on a lower surface of the moving cutter 38 and the second dovetail member 48, for example, the dovetail slot, may be formed on an upper surface of the of the bearing plate 26. In addition, the first and second dovetail members 46, 48 define a travel path for the moving cutter 38 to move reciprocally in the first direction D1 toward the cutting position and the second direction D2 toward the retracted position (FIG. 2).

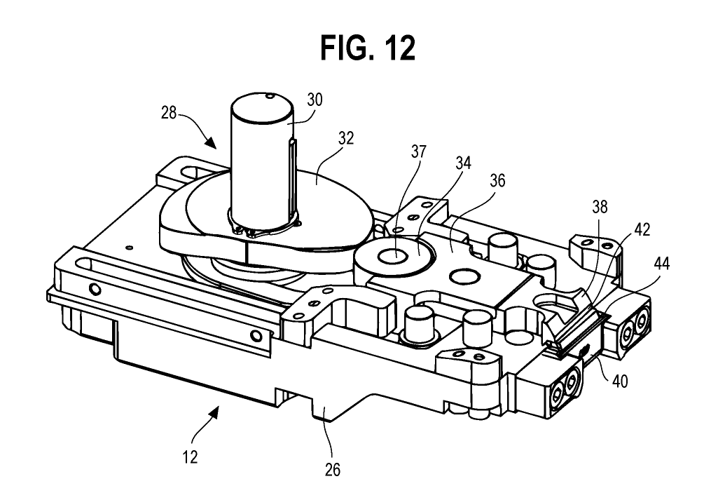

FIG. 12 is a perspective view showing the base portion 12 in a substantially assembled condition. As shown in FIG. 12, in one embodiment, the eccentric cam block 32 may be positioned in abutting relationship with the first cam follower 34. Rotation of the eccentric cam block 32 may drive the moving cutter 38, via the first cam follower 34 and cutter block 36 in the first direction D1 toward the cutting position. In one example, the first cam follower 34 may be rotatable or fixed the pin 37 (see FIG. 2). The pin 37 may connect the first cam follower 34 to the cutter block 36 and transmit a linear force applied on the first cam follower 34 from the eccentric cam block 32 to the cutter block 36. The cutter block 36 may be slidably positioned on or coupled to the bearing plate 26, and thus, may be driven in the first direction D1 in response to rotation of the eccentric cam block 32. The cutter block 36 may be secured to the moving cutter 38. Thus, the moving cutter 38 may be driven in the first direction D1 together with the cutter block 36.

In use, a strap is positioned around a load and tensioned. The strap may be fed along the feed path 22. The strap may be looped over itself, i.e., a length at one end may overlap a length at another end and the overlapping ends may be sealed together. In one embodiment, the notchers 18 may form one or more notches for securing and sealing overlapping ends of the strap to one another. A feed end of the strap may then be cut.

The strap may be cut by driving moving cutter 38 in the first direction D1 in response to rotation of the eccentric cam block 32. As the moving cutter 38 approaches the stationary cutter 40, the first shearing surface 42 is configured to engage one side of the strap. Continued movement of the moving cutter 38 toward the stationary cutter 40 is configured to bring an opposite side of the strap into contact with the second shearing surface 44 of the stationary cutter 40 so as to capture the strap between the first and second shearing surfaces 42, 44. The moving cutter 38 and the stationary cutter 40 are configured shear the strap in response to further movement of the moving cutter 38 toward the stationary cutter 40 to the cutting position. In a direction of the strap feed path 22, substantially perpendicular to the first direction D1, a clearance between the moving cutter 38 and stationary cutter 40 preferably does not exceed about 0.0025 inches.

In the embodiments above, the clearance between the moving cutter 38 and the stationary cutter 40 in a direction of the strap feed path 22, substantially perpendicular to the first direction D1, can be maintained at a desired, predetermined distance, without the need for shims to adjust the clearance.

In the embodiments above, the clearance may be minimized and stably maintained as result of the dovetail coupling configurations. In one embodiment, the moving cutter 38 is slidably coupled to the bearing plate 26 by way of first and second dovetail members 46, 48. A desired clearance may be predetermined and the dovetail coupling may be manufactured to provide the desired clearance. Accordingly, in the embodiments above, it is not necessary to insert a shim or shims between the bearing plate 26 and one of or both of the moving cutter 38 and the stationary cutter 40.

By maintaining a maximum gap of, for example, 0.0025 inches between the moving cutter 38 and stationary cutter 40, and in particular, between the respective shearing surfaces 42, 44 of the moving cutter 38 and stationary cutter 40, a clean cut may be provided at the feed end of the strap at any angle. Further still, the dovetail coupling, i.e., the first and second dovetail members 46, 48 provide for increased strength compared to conventional configurations. Thus, the dovetail coupling may be able to withstand higher loads in the event the first and second shearing surfaces 46, 48 become dull and loads are increased during cutting. Also, due to a the full length of the dovetail coupling, the moving cutter 38 resists the tendency to rise up at the point of cutting or shearing as the respective cutting edges engage the strap.

It should also be understood that various changes and modifications to the presently disclosed embodiments will be apparent to those skilled in the art. Such changes and modifications can be made without departing from the spirit and scope of the present disclosure and without diminishing its intended advantages. It is therefore intended that such changes and modifications be covered by the appended claims.

1. A strap sealing module comprising:
a moving cutter having a first shearing surface and a first dovetail member;
a bearing plate having a second dovetail member, the first dovetail member matingly and slidably coupled with the second dovetail member to slidably couple the moving cutter to the bearing plate; and
a stationary cutter fixedly secured to the bearing plate, the stationary cutter having a second shearing surface,
wherein a strap feed path is defined between the moving cutter and the stationary cutter, and the moving cutter is slidable along the bearing plate in a first direction toward the stationary cutter so as to overlap the stationary cutter by a predetermined clearance in a cutting position, and slidable in a second direction away from the stationary cutter to a retracted position.

2. The strap sealing module of claim 1, wherein the first dovetail member is one of a dovetail slot and a dovetail projection and the second dovetail member is the other of the dovetail slot and dovetail projection.

3. The strap sealing module of claim 2, wherein the first dovetail member is the dovetail projection and the second dovetail member is the dovetail slot.

4. The strap sealing module of claim 1, wherein the stationary cutter is fixedly secured to the bearing plate with one or more fastening bolts.

5. The strap sealing module of claim 1, wherein the first and second shear surfaces are configured to engage opposite sides of a strap fed through the strap feed path and cut the strap.

6. The strap sealing module of claim 1, further comprising a cam assembly configured to drive the moving cutter in the first direction.

7. The strap sealing module of claim 6, wherein the cam assembly includes a rotatable eccentric cam block secured to a cam shaft and a cam follower connected to the moving cutter.

8. The strap sealing module of claim 7, wherein the cam assembly is configured to drive the moving cutter in the second direction.

9. The strap sealing module of claim 1, wherein the clearance does not exceed about 0.0025 inches.

10. The strap sealing module of claim 1, further comprising a spring-biased ball detent to hold the moving cutter in the retracted position.

11. A cutting assembly for a strap sealing module, the cutting assembly comprising:
a moving cutter having a first shearing surface and a first dovetail member;
a bearing plate having a second dovetail member, the first dovetail member matingly and slidably coupled with the second dovetail member to slidably couple the moving cutter to the bearing plate; and
a stationary cutter fixedly secured to the bearing plate, the stationary cutter having a second shearing surface,
wherein the moving cutter is slidable along the bearing plate in a first direction toward the stationary cutter so as to overlap the stationary cutter by a predetermined clearance in a cutting position, and slidable in a second direction away from the stationary cutter to a retracted position.

12. A moving cutter for use in a cutting assembly of a strap sealing module, the moving cutter comprising:
a shearing surface; and
a dovetail member configured to matingly and slidingly engage a corresponding dovetail member of an adjacent bearing plate.

13. The moving cutter of claim 12, wherein the dovetail member is a dovetail projection.

14. The moving cutter of claim 12, wherein the shearing surface is a blade edge.
